(19) United States
(12) Patent Application Publication
(10) Pub. No.: US 2026/0321809 A1
(43) Pub. Date: Oct. 15, 2026

(54) PACKAGED BATTERY

(71) Applicant: Panasonic Intellectual Property Management Co., Ltd., Osaka (JP)

(72) Inventors: TOORU MORIMOTO, Nara (JP); SAYURI NAKATA, Osaka (JP); TOYOTAKA KATO, Osaka (JP)

(21) Appl. No.: 19/484,538

(22) PCT Filed: Jan. 26, 2024
(86) PCT No.: PCT/JP2024/002390

§ 371 Date: Nov. 14, 2025

(30) Foreign Application Priority Data
May 31, 2023 (JP) 2023-089765

(51) Int. Cl. H01M 50/105; H01M 10/48; H01M 50/121; H01M 50/124

(52) U.S. Cl. CPC H01M 50/105; H01M 10/488; H01M 50/121; H01M 50/124

(57) ABSTRACT

The packaged battery includes a battery and a packaging bag that accommodates the battery. The disclosed packaging bag is a battery packaging bag in which a battery is accommodated. The packaging bag includes at least one sheet of laminated paper including a paper layer and a resin layer laminated on one surface of the paper layer. The at least one sheet of laminated paper is formed into a bag shape forming a sealed space in which the battery is accommodated, the resin layer of the at least one sheet of laminated paper including different portions welded to each other. The thickness of the resin layer is in the range of 50 μm to 60 μm. At least the surface layer of the resin layer is made of a resin having a melting point of 107° C. or lower.

### TECHNICAL FIELD

The present disclosure relates to a packaged battery.

### BACKGROUND ART

Batteries are distributed in a packaged state. Conventionally, various proposals have been made for packaging batteries. Patent Literature 1 (JP 2023-010596 A) describes in claim 1 “a packaging unit (100; 200; 300; 400) for at least two button cells (50), the packaging unit (100; 200; 300; 400) characterized by that:
(a) the packaging unit comprises, for each of the button cells (50), an independent and individual compartment (10) enclosing the button cell,
(b) each of the independent and individual compartments (10) is formed of an independent thermoformed plastic hood (11) and a rear surface plastic film (12) fixed thereto,
(c) the independent and individual compartments (10) are configured such that independent and individual compartments (10) cannot be opened without a tool,
(d) the packaging unit comprises a carrier (20) to which the individual compartments (10) are attached, and
(e) The independent and individual compartments (10) are spaced apart from one another on the carrier (20)”.

In addition, Patent Literature 2 (Japanese Design Publication No. 1607532) discloses a design of a battery packaging container in which measures against accidental ingestion are taken.

### CITATION LIST

### Patent Literature

Patent Literature 1: Unexamined Japanese Patent Publication No. 2023-010596
Patent Literature 2: Japanese Design Publication No. 1607532

### SUMMARY

Conventionally, blister packs have been widely used for packaging batteries. However, blister packs have many problems that a large amount of petroleum resources are used and that a large amount of carbon dioxide during incineration is emitted. Therefore, there is currently a need for packaging that replaces blister packs. Furthermore, the packaging of batteries is required to prevent accidental ingestion by infants and toddlers.

A packaged battery according to one aspect of the present disclosure includes a battery and a packaging bag that accommodates the battery therein. The packaging bag includes at least one sheet of laminated paper including a paper layer and a resin layer laminated on one surface of the paper layer. The at least one sheet of laminated paper is formed into a bag shape forming a sealed space in which the battery is accommodated. The resin layer of the at least one sheet of laminated paper includes different portions welded to each other. A thickness of the resin layer is in a range of 50 μm to 60 μm, and at least a surface layer of the resin layer is made of a resin having a melting point of 107° C. or lower.

In the present disclosure, it is possible to obtain a packaging bag using laminated paper and having a high effect of preventing accidental ingestion of a battery.

### BRIEF DESCRIPTION OF DRAWINGS

FIG. 1A schematically shows a top view of an example of a packaged battery of a first embodiment.

FIG. 1B schematically shows a cross-section of the packaged battery of FIG. 1A taken along line IB-IB.

FIG. 2A is a perspective view for explaining another example of the packaging bag of the first embodiment.

FIG. 2B is a perspective view for explaining another example of the packaging bag of the first embodiment.

FIG. 3 is a perspective view for explaining another example of the packaging bag of the first embodiment.

FIG. 4 is a perspective view for explaining another example of the packaging bag of the first embodiment.

### DESCRIPTION OF EMBODIMENT

Hereinafter, an embodiment according to the present disclosure will be described with examples, but the present disclosure is not limited to the examples described below. In the following description, specific numerical values and materials may be exemplified, but other numerical values and other materials may be applied as long as the effects of the present disclosure are obtained. In the present specification, the expression “numerical value A to numerical value B” includes the numerical value A and the numerical value B, and can be read as “numerical value A or more and numerical value B or less”. In the following description, when lower limits and upper limits of numerical values relating to specific physical properties and conditions are exemplified, any of the exemplified lower limits and any of the exemplified upper limits can be arbitrarily combined as long as the lower limit is not equal to or greater than the upper limit. In the following description, when examples of constituent elements or examples of methods are listed, only one of the listed examples may be used or a plurality of the listed examples may be used in combination unless otherwise specified.

### (Battery Packaging Bag)

Hereinafter, the packaging bag according to the present embodiment may be referred to as a packaging bag (P). The packaging bag (P) is a battery packaging bag in which a battery is accommodated. The packaging bag (P) includes at least one sheet of laminated paper including a paper layer and a resin layer laminated on one surface of the paper layer. The at least one sheet of laminated paper is formed into a bag shape in which the entire opening is sealed by welding the resin layers of different portions. In the embodiment, the welding is thermal welding, but may be other welding, for example, welding by pressure. The thickness of the resin layer is in the range of 50 μm to 60 μm. At least the surface layer of the resin layer is made of a resin having a melting point of 107° C. or lower. The “surface layer” of the resin layer means a layer on the surface opposite to the paper layer of the two surfaces of the resin layer.

Since a large amount of resin is not used for the packaging bag (P) unlike the blister pack, the amount of petroleum resources used is small, and the environmental load at the time of disposal is small. Furthermore, the packaging bag (P) can suitably prevent accidental ingestion of the battery in the following points.

The thickness of the resin layer of the laminated paper used for packaging is generally 30 μm or less in many cases. However, the present inventors have found that when the thickness of the resin layer is less than 50 μm, the package is easily broken, which is not preferable in terms of prevention of accidental ingestion by infants and toddlers. On the other hand, the present inventors have found that when the thickness of the resin layer is more than 60 μm, the amount of heat required for thermal welding increases, and thermal welding becomes difficult. The present disclosure is based on these new findings.

The packaging bag (P) is formed using a laminated paper including a resin layer having a thickness of 50 μm or more. Therefore, the packaging bag (P) is less likely to be broken, which is advantageous in terms of prevention of accidental ingestion. When the thickness of the resin layer is 60 μm or less, heat is easily transferred, and highly reliable thermal welding can be easily performed. Furthermore, since a resin layer having a low melting point (melting point: 107° C. or lower) is used as the surface layer of the resin layer, thermal welding can be reliably performed even when the thickness of the resin layer is 50 μm or more, and defects in thermal welding can be suppressed. As described above, the packaging bag (P) formed using the laminated paper has a high effect of preventing accidental ingestion of a battery and is easy to manufacture.

The packaging bag (P) preferably has the following features (1) and/or (2).
(1) The packaging bag (P) does not have a structure that facilitates tearing the packaging bag (P) by hand.
(2) A cutting instruction line is printed on the surface.

As the feature (1), the packaging bag (P) preferably has at least one of the following features (1A) to (1C). For example, the packaging bag (P) may have any one of the following three features, may have any two of the following features (1A and 1B, 1A and 1C, or 1B and 1C), or may have all of the three features.
(1A) The outer peripheral portion of the packaging bag (P) has no notch.
(1B) No incision for opening is made in the packaging bag (P).
(1C) In the welded portion, the laminated paper is welded (thermally welded in the embodiment) up to the end portion thereof.

Regarding the feature (1A), examples of the notch include a notch formed by cutting out only a part of the outer peripheral portion and a notch formed by cutting out the entire outer peripheral portion in a zigzag manner. Regarding the feature (1B), examples of the cut include a perforation and a cut formed in the outer peripheral portion. The planar shape of an example of the packaging bag (P) satisfying the feature (1A) is a rectangle in which the outer periphery thereof is constituted by four straight lines.

The distance between the end portion of the laminated paper in the thermally welded portion and the thermally welded portion is defined as a distance L. In other words, the distance L is a width of an unlaminated portion between the end portion of the laminated paper and the welded portion. By reducing the distance L, the gap for inserting a finger can be reduced. The distance L is preferably 3 mm or less, and more preferably 1 mm or less. When the feature (1C) is satisfied, the distance L is 0 mm.

Regarding the above feature (2), the cutting instruction line is printed at a position where the battery can be taken out by cutting the portion with scissors. Specifically, the cutting instruction line is printed so as to pass through a portion that is not thermally welded. The cutting instruction line may be printed on only one surface of the packaging bag (P) or may be printed on both surfaces thereof.

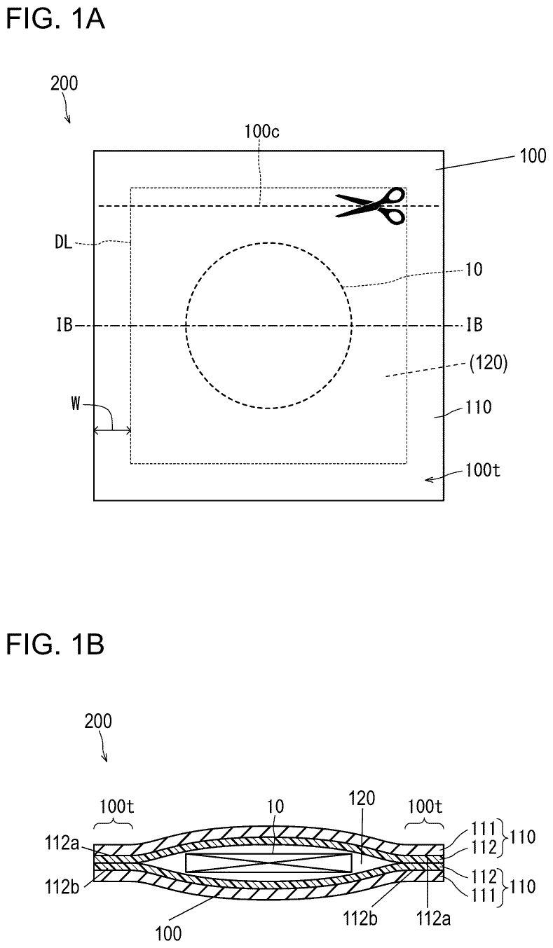

The width W (see FIG. 1A) of the welded portion to be thermally welded may be 3 mm or more or 5 mm or more, and may be 10 mm or less or 8 mm or less. By setting the width W to 3 mm or more, the reliability of thermal welding can be enhanced. It should be noted that the width W of a part of the welded portion may be increased, and a hole for hanging may be formed in the part.

The method for forming the laminated paper used for forming the packaging bag (P) is not particularly limited, and the laminated paper may be formed by a known method. The laminated paper used for forming the packaging bag (P) can be formed by a method of laminating a resin sheet serving as a resin layer on one surface of paper. Alternatively, laminated paper may be formed by thinly coating one side of paper with molten resin. Usually, the resin layer is formed only on the surface to be thermally welded out of the two surfaces of the paper layer. That is, the laminated paper is usually composed of one paper layer and a resin layer laminated on one surface of the paper layer.

### (Paper Layer)

The basis weight (i.e., surface density) of the paper layer is preferably in the range of 45 g/m² to 85 g/m². When the basis weight of the paper layer is 45 g/m² or more, the packaging bag (P) having a high effect of protecting the battery against external impact can be obtained. When the basis weight of the paper layer is 85 g/m² or less, folding becomes easy, and as a result, production of the packaging bag (P) becomes easy. The basis weight of the paper layer may be 45 g/m² or more, 55 g/m² or more, or 65 g/m² or more, and may be 85 g/m² or less, 75 g/m² or less, or 65 g/m² or less.

The proportion of the paper layer in the packaging bag (P) may be 50% by mass or more. When the proportion of the paper layer is 50% by mass or more, the amount of petroleum resources used and the environmental load at the time of disposal can be particularly reduced. The proportion of the paper layer may be 50% by mass or more or 55% by mass or more, and may be 95% by mass or less or 90% by mass or less.

The thickness of the paper layer may be 50 μm or more, or 60 μm or more, and may be 110 μm or less, or 100 μm or less. The paper layer of the packaging bag (P) may satisfy the following conditions (3) and (4).
(3) The basis weight of the paper layer is in the range of 45 g/m² to 85 g/m². The basis weight of the paper layer may be in the above range.
(4) The thickness of the paper layer is in the range of 50 μm to 110 μm. The thickness of the paper layer may be in the above range.

The paper layer is not particularly limited, and known paper used for packaging bags may be used. The fiber material constituting the paper layer is not particularly limited, and a fiber material constituting known paper used for a packaging bag may be used. Examples of fiber materials include wood pulp and other fiber materials. A preferred example of a fiber material is a natural fiber material such as wood pulp. As the wood pulp, hardwood pulp, softwood pulp, and a mixture thereof may be used.

### (Resin Layer)

Hereinafter, a resin (e.g., a thermoplastic resin) having a melting point of 107° C. or lower may be referred to as a “low-melting-point resin”, and a layer formed of a resin having a melting point of 107° C. or lower may be referred to as a “low-melting-point resin layer”. The resin layer may be a single-layer resin layer or a resin layer composed of a plurality of layers. When the resin layer is a single-layer resin layer, the entire resin layer is made of the low-melting-point resin.

When the resin layer is composed of a plurality of layers (for example, two or three layers), at least the surface layer is composed of a low-melting-point resin. In this case, in order to enhance the reliability of thermal welding, the thickness of the low-melting-point resin layer is preferably 30 μm or more (for example, 40 μm or more). The melting point of the resin layer other than the surface layer is not particularly limited, and may be 107° C. or lower or higher than 107° C.

As the low melting point resin, an insulating crystalline resin having a melting point of 107° C. or lower can be used. The low-melting-point resin is not particularly limited, and a known thermoplastic resin may be used. A polyolefin having a melting point of 107° C. or lower may be used as the low-melting-point resin. The polyolefin may be polyethylene in which a small amount of α-olefin other than ethylene is copolymerized with ethylene. Examples of α-olefins copolymerized with ethylene include 1-butene, 1-hexene, 1-octene, and other α-olefins.

Examples of the polyolefin having a melting point of 107° C. or lower include linear low-density polyethylene having a melting point of 107° C. or lower. Currently, resins (for example, polyolefins) having various melting points are commercially available, and thus these resins can be used.

When the resin layer is composed of a plurality of layers, a layer composed of a resin having high adhesion to the paper layer may be used as the resin layer in contact with the paper layer. By using such a resin layer, peeling of the paper layer and the resin layer can be suppressed. Examples of the resin having high adhesion to the paper layer include polyethylene, polypropylene, and polyethylene terephthalate.

If the melting point of the resin constituting the resin layer is too low, there is a possibility that the strength of the welded portion may decrease when the welded portion is placed in a high-temperature environment. Therefore, the melting point of the resin constituting the resin layer is preferably 80° C. or higher (for example, 85° C. or higher).

The resin layer is formed at least in a portion to be thermally welded. Usually, the resin layer is formed on the entire one surface of the paper layer. In this case, the low-melting-point resin layer is present on the surface of the laminated paper facing the internal space in which the battery is accommodated. In other words, the internal space in which the battery is accommodated is surrounded by the low-melting-point resin layer.

The thickness of the laminated paper may be 100 μm or more or 110 μm or more, and may be 170 μm or less or 160 μm or less.

The battery contained in the packaging bag (P) is not particularly limited. The size and shape of the packaging bag are selected depending on the size and shape of the battery. Examples of the shape of the battery include a cylindrical shape, a rectangular shape, a pin shape, and a flat shape. Examples of the pin-shaped battery include a columnar battery having a diameter of 5 mm or less (for example, 4 mm or less). Examples of the flat battery include a button-shaped battery and a coin-shaped battery. The packaging bag (P) can be preferably used for packaging a pin-shaped or flat battery.

The shape of the packaging bag (P) is not particularly limited. An example of the planar shape of the packaging bag (P) is a rectangular shape. The structure of the packaging bag (P) (for example, the number of laminated papers and the manner of folding the laminated paper) is not limited. The number of laminated papers and the manner of folding the laminated paper may be the same as the number of packaging materials and the manner of folding the packaging material used in known packaging bags. Examples of the structure of the packaging bag (P) include a flat bag, a gusset bag, and a standing bag. The shape of the bottom surface of the standing bag may be a ship bottom shape or a rectangular shape. A specific example of the structure of the packaging bag (P) will be described later.

The packaging bag (P) may be sealed. Alternatively, the packaging bag (P) may be provided with an air hole for the purpose of suppressing expansion of the packaging bag (P). Unlike perforations, air holes are not holes for opening the bag. The air hole is, for example, a hole having a diameter of 2 mm or less (for example, 1 mm or less). The number of air holes formed in one packaging bag (P) is usually small (for example, three or less).

### (Manufacturing Method of Packaging Bag (P))

The packaging bag (P) can be manufactured by disposing the battery at a position corresponding to an internal space of the packaging bag (P) and then thermally welding the resin layer at a position where sealing is required. At this time, before the battery is disposed, a part of the resin layer in a place where sealing is required may be thermally welded in advance. For example, first, two or three sides may be thermally welded to form a rectangular bag with only one side open. Next, the battery is disposed in the bag, and finally, the resin layer of the opening may be thermally welded. In this manner, the packaging bag (P) in which the battery is accommodated can be manufactured.

Alternatively, a plurality of packaging bags may be thermally welded at a time. In an exemplary manufacturing method, first, batteries are arranged in a matrix on a large laminated paper, and the large laminated paper is stacked thereon. Next, the resin layer is thermally welded in a grid pattern so that one battery is arranged in one grid. Thereafter, the center of the thermally welded portion is cut to separate each packaging bag (P). In this manner, the packaging bag (P) in which the battery is accommodated can be manufactured.

The thermal welding method is not particularly limited, and may be a known method or may be performed using a known thermal welding machine. For example, thermal welding may be performed by pressing a heated plate (for example, a metal plate) onto the laminated paper from the outside (i.e., from the paper layer). In this case, the heated plate may be pressed onto only one of the two laminated papers to be bonded. Alternatively, two heated plates may be pressed onto each other so as to sandwich the two laminated papers to be bonded. The heating temperature of the plate is higher than the melting point of the resin used for thermal welding (at least the resin of the surface layer). When the melting point of the resin constituting the surface layer of the resin layer is T (° C.), the heating temperature of the plate may be T+10° C. or higher (for example, T+20° C. or higher), and may be T+40° C. or lower (for example, T+30° C. or lower). By lowering the heating temperature, it is possible to prevent the paper from being scorched or printing from being unclear. The heating temperature of the plate may be 120° C. or lower.

In another aspect, the present disclosure discloses a battery accommodated in a packaging bag (P). Since the packaging bag (P) and the battery accommodated therein have been described above, redundant description will be omitted. Since the packaging bag (P) is not easily torn by hand, the battery accommodated in the packaging bag (P) can be prevented from being accidentally ingested, and is highly safe.

Hereinafter, examples of embodiments according to the present disclosure will be specifically described with reference to the drawings. The embodiments described below can be modified based on the above description. Further, the matters described below may be applied to the above-described embodiment. In addition, in the embodiment described below, matters that are not essential to the invention according to the present disclosure may be omitted.

### First Embodiment

In the first embodiment, an example of the structure of the packaging bag (P) is shown. FIG. 1A shows a top view of an example of a packaging bag 100 of the first embodiment, and FIG. 1B shows a cross-sectional view taken along line IB-IB. As shown in FIGS. 1A and 1B, the packaging bag 100 is a flat bag formed by bonding two sheets of laminated paper 110. The laminated paper 110 includes a paper layer 111 and a resin layer 112 laminated on one surface of the paper layer 111. The laminated paper 110 is the laminated paper described above. The packaged battery 200 includes a battery 10 and a packaging bag 100 that accommodates the battery 10.

Outer peripheral portions of the two sheets of laminated paper 110 are welded (thermally welded in the embodiment) to form a welded portion 100t. Specifically, the region between the dotted line DL and the outer periphery in FIG. 1A is the welded portion 100t. FIG. 1A illustrates a width W of the welded portion 100t. As shown in FIG. 1B, in the welded portion 100t of the packaging bag 100, the laminated paper 110 is thermally welded up to the end portion. That is, the distance L described above is zero. In this manner, the two sheets of laminated paper 110 are formed in a bag shape in which all the openings are sealed. A battery 10 (for example, a coin-shaped battery) is disposed in the internal space. That is, the different portions 112a and 112b of the resin layer 112 of at least one (here, two) laminated paper 110 are thermally welded to each other, and at least one laminated paper 110 is formed in a bag shape forming the sealed space 120 in which the battery 10 is accommodated. The resin layer 112 faces the sealed space 120 and forms the sealed space 120 so as to completely surround the sealed space 120.

The outer periphery of the packaging bag 100 has no notch. The packaging bag 100 is not perforated. The outer periphery of the packaging bag 100 shown in FIG. 1A is composed of four straight lines.

As shown in FIG. 1A, a cutting instruction line 100c is printed on the surface of the packaging bag 100. The cutting instruction line 100c is printed so as to pass through a non-welded region (i.e., a region that is not thermally welded) having a length such that the battery 10 is allowed to be taken out. The battery 10 can be easily taken out by cutting the packaging bag 100 along the cutting instruction line 100c with scissors.

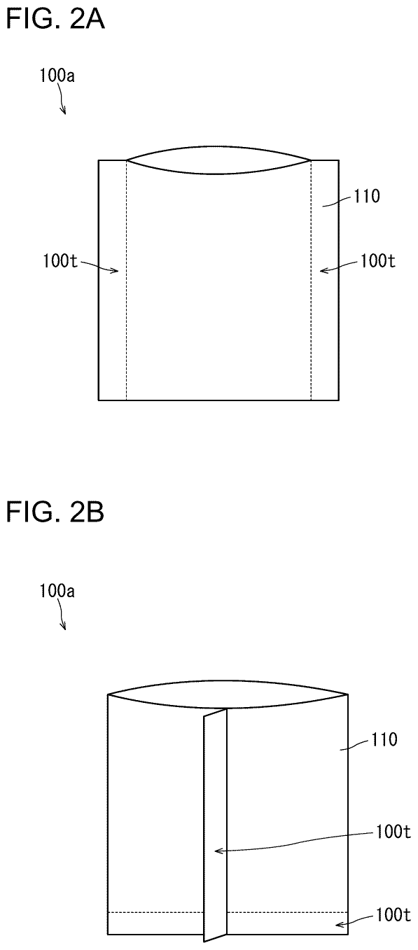

FIGS. 2A and 2B schematically show perspective views of other examples of the packaging bag (P) which is a flat bag. The packaging bag 100a shown in FIGS. 2A, 2B, 3, and 4 is in a state before the battery 10 is placed therein. After the battery 10 is placed in each packaging bag 100a, one side of the opening is thermally welded to obtain a packaging bag (P) in which the battery 10 is accommodated.

The packaging bag 100a shown in FIG. 2A is formed by folding one sheet of laminated paper 110 and thermally welding two sides. The packaging bag 100a shown in FIG. 2B is formed by folding one sheet of laminated paper 110 as shown in FIG. 2B and thermally welding two portions of the bottom portion and the back surface of the bag. Butt seaming is performed on the back surface of the bag to join the back surface. FIG. 2B is a view of the packaging bag 100a as viewed from the rear surface on which butt seaming is performed.

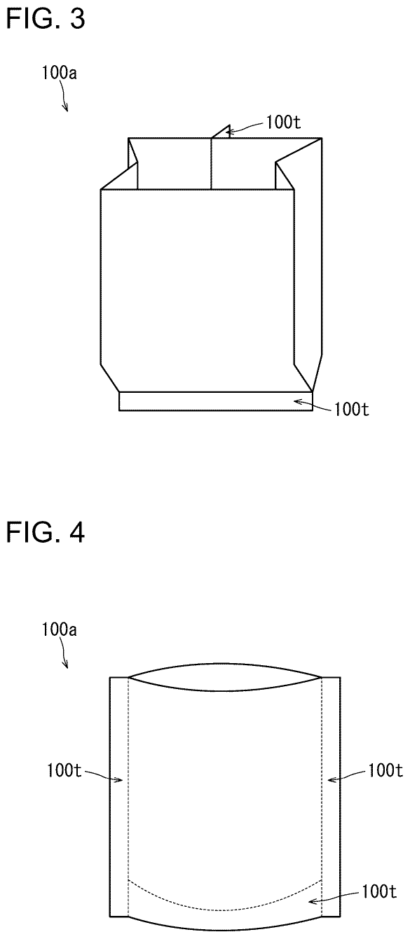

The packaging bag (P) may have a shape other than a flat bag. As described above, the packaging bag (P) may be a gusset bag having a gusset, or may be a self-standing standing bag. FIG. 3 schematically shows a perspective view of an example of a packaging bag (P) which is a gusset bag having a gusset. The packaging bag 100a shown in FIG. 3 is formed by folding one sheet of laminated paper 110 as shown in FIG. 3 and thermally welding two portions of a bottom portion and a bag back surface. Butt seaming is performed on the back surface of the bag to join the back surface.

FIG. 4 schematically shows a perspective view of an example of a packaging bag (P) which is a standing bag. The packaging bag 100a shown in FIG. 4 is formed by bonding two sheets of laminated paper 110 and one sheet of laminated paper as a bottom surface by thermal welding. The number of sheets of the laminated paper 110 used for forming the packaging bag (P) and the position of the welded portion are not limited to the example described in the first embodiment.

### (NOTES)

The following techniques are disclosed by the above description.

### (Technique 1)

A packaged battery, comprising:
a battery;
a packaging bag accommodating the battery therein,
wherein
the packaging bag includes at least one sheet of laminated paper including a paper layer and a resin layer laminated on one surface of the paper layer,
the at least one sheet of laminated paper is formed into a bag shape forming a sealed space in which the battery is accommodated, the resin layer of the at least one sheet of laminated paper including different portions thermally welded to each other,
the thickness of the resin layer is in the range of 50 μm to 60 μm, and
at least a surface layer of the resin layer comprises a resin having a melting point of 107° C. or lower.

### (Technique 2)

The packaged battery of the technique 1, wherein the packaged battery has an outer peripheral portion free from a notch.

### (Technique 3)

The packaged battery of the technique 1 or 2, wherein a cutting instruction line is printed on the surface of the packaged battery.

### (Technique 4)

The packaged battery of any one of the techniques 1 to 3, wherein a basis weight of the paper layer is in a range of 45 g/m² to 85 g/m².

### (Technique 5)

The packaged battery according to any one of the techniques 1 to 4, wherein a proportion of the paper layer is 50% by mass or more.

### EXAMPLES

Hereinafter, the present disclosure will be specifically described based on Examples, but the present disclosure is not limited to the following Examples.

In the present examples, 25 packaging bags were produced and evaluated. The structure of the packaging bag was the same as that of the packaging bag 100 shown in FIGS. 1A and 1B. In the present examples, a plurality of packaging bags were produced by changing the thickness of the resin layer and the melting point of the resin constituting the resin layer. The resin layer was a single resin layer. The thickness of the resin layer was 45 μm, 50 μm, 55 μm, 60 μm, or 65 μm. The melting point of the resin used in the resin layer was 95° C., 99° C., 103° C., 107° C., or 111° C. As the resin, linear low-density polyethylene copolymerized with a small amount of α-olefin other than ethylene was used. A cutting instruction line was printed on the surface of the paper. The thermal welding was performed by pressing a plate heated to a temperature about 10° C. higher than the melting point of the resin constituting the resin layer onto a laminated paper.

The following items were evaluated for the manufactured packaging bags and the manufacturing process thereof.
(1) Whether or not the produced packaging bags were hardly torn by hand (whether or not prevention of accidental ingestion is effective).
(2) Whether or not the surface of the paper was scorched during thermal welding (whether or not the printed content is clear).
(3) Whether or not thermal welding was easy.

The evaluation results of the produced 25 packaging bags are shown in Table 1.

TABLE 1

| Melting | |
|---|---|
| point of | |
| Resin | Thickness of Resin Layer (μm) |

| (° C.) | 45 | 50 | 55 | 60 | 65 |
|---|---|---|---|---|---|
| 95 | B | A | A | A | C |
| 99 | B | A | A | A | C |
| 103 | B | A | A | A | C |
| 107 | B | A | A | A | C |
| 111 | B, D | D | D | D | C, D |

The 12 packaging bags in each of which the melting point of the resin is 107° C. or lower and each of which has the resin layer having a thickness within the range of 50 to 60 μm are the packaging bag (P) according to the present disclosure. The other 13 packaging bags are comparative examples.

In Table 1, B to D indicate the following evaluation results.
B: The resin layer was easily broken, and the effect of preventing accidental ingestion was low.
C: Heat was hardly transferred, and thermal welding was difficult (larger thermal energy was required for thermal welding).
D: Since the paper was scorched, the printed content became unclear.

In Table 1, “A” does not correspond to the problems B to D and indicates that a good result was obtained. That is, “A” indicates that the resin layer was hardly broken and the accidental ingestion prevention effect was high, heat was easily transferred and thermal welding was easily performed, and the surface of the paper was not scorched and the printed content was clear.

As shown in Table 1, the packaging bag (P) according to the present disclosure had a high effect of preventing accidental ingestion. Further, the packaging bag (P) was easily thermally welded and could be easily produced with high reliability.

### INDUSTRIAL APPLICABILITY

The present disclosure is applicable to a packaged battery.

### REFERENCE SIGNS LIST

10 battery
100 packaging bag
100a packaging bag
100c cutting instruction line
100t welded portion
110 laminated paper
111 paper layer
112 resin layer
200 packaged battery

1. A packaged battery comprising:
a battery; and
a packaging bag accommodating the battery therein,
wherein
the packaging bag includes at least one sheet of laminated paper including a paper layer and a resin layer laminated on one surface of the paper layer,
the at least one sheet of laminated paper is formed into a bag shape forming a sealed space in which the battery is accommodated, the resin layer of the at least one sheet of laminated paper including different portions welded to each other,
a thickness of the resin layer is in a range of 50 m to 60 μm, and
at least a surface layer of the resin layer is made of a resin having a melting point of 107° C. or lower.

2. The packaged battery according to claim 1, wherein
the packaged battery has an outer peripheral portion free from a notch.

3. The packaged battery according to claim 1, wherein
a cutting instruction line is printed on a surface of the packaged battery.

4. The packaged battery according to claim 1, wherein
a basis weight of the paper layer is in a range of 45 g/m² to 85 g/m².

5. The packaged battery according to claim 1, wherein
a ratio of the paper layer is 50% by mass or more.
